(19) United States
(12) Patent Application Publication
(10) Pub. No.: US 2018/0292867 A1
(43) Pub. Date: Oct. 11, 2018

(54) METHOD FOR RECORDING AN IMAGE USING A MOBILE DEVICE

(71) Applicant: Robert Bosch GmbH, Stuttgart (DE)

(72) Inventors: Hendrik Specht, Pliezhausen (DE); Frank Fischer, Gomaringen (DE); Georg Mrusek, Reutlingen (DE)

(21) Appl. No.: 15/766,702

(22) PCT Filed: Aug. 11, 2016
(86) PCT No.: PCT/EP2016/069144

§ 371 Date: Apr. 6, 2018

(30) Foreign Application Priority Data
Oct. 8, 2015 (DE) 102015219538.4

(51) Int. Cl. G06F 1/16; G03B 15/05; H04M 1/02; H04N 5/235

(52) U.S. Cl. CPC G06F 1/1686; G03B 15/05; H04N 5/2354; H04M 1/0272; H04N 5/2353; G06F 1/1639

(57) ABSTRACT

A method for recording an image using a mobile device, the mobile device including a camera unit, a detection area being assigned to the camera unit, the mobile unit including a projection unit, a projection area being assigned to the projection unit, the detection area and the projection area at least partially overlapping, a piece of image information being projected into the detection area in a first method step, a recording medium of the camera unit being exposed in a second method step, which follows the first method step, the image generated by the exposure of the recording medium being stored in the mobile device in a third method step.

### FIELD

The present invention is directed to a method for recording an image using a mobile device.

### BACKGROUND INFORMATION

A mobile device is typically used to record a camera image, which is, for example a photo camera (standalone device) or a mobile computer device (smartphone, tablet computer, laptop, etc.), into which the digital photo camera is integrated.

However, digital projectors for stationary applications may be considered, for example in a conference room or in a movie theater. In miniaturized form, digital projectors are used both as a standalone device and integrated into smartphones for mobile applications.

Digital photo cameras and image processing software typically include algorithms for digital photo effect filters to modify a recorded image after recording.

Structured-light projectors may be used for measuring methods for the three-dimensional detection of surface shapes.

The disadvantage of conventional methods and devices is that the recorded images may be processed only subsequently (i.e., after recording), and photographic design options are limited thereby.

### SUMMARY

An object of the present invention is therefore to expand the photographic design options and to increase the range of functions of the mobile devices.

The example mobile device according to the present invention and the example method according to the present invention for recording an image using a mobile device may have the advantage over the related art that a piece of image information projected into the detection area is added to an object (or a photo scene) before and/or during a recording of the image. The image information is preferably superimposed onto the object in such a way that the image information appears together with the object on the recorded image. In particular, the image information projected onto the object (or into the photo scene before and/or during the image recording) includes decorative image elements and/or image elements supporting the photographer during the recording and/or metrological image elements and/or image elements for reconstructing a spatial, physical characteristic of the photographed object.

According to the present invention, the mobile device (which is, in particular, a smartphone) preferably includes a projection unit designed as a scanning laser projector. This makes it advantageously possible, according to the present invention, to achieve a comparatively great depth of field. According to the present invention, the projection unit and the camera unit are integrated into the mobile device in such a way that the projection area of the projection unit (which is also referred to here as the image field of the projector or the projection image field) and the detection area of the camera unit (which is also referred to here as the image field of the camera or the camera image field) overlap. The projection area is preferably (partially or completely) surrounded by the detection area of the camera unit, the projection area, in particular, completely filling the detection area. The detection area and the projection area are preferably congruent, so that the camera unit is able to optically detect the images—which are generated by the projection unit on an object (for example on a projection screen) positioned within the detection area of the camera unit. In particular, the camera unit and the projection unit form an optical assembly, the projection functionality and the camera functionality being provided by the optical assembly. According to the present invention, the camera unit and, in particular, additionally a camera flash device of the mobile device (preferably a flash device including a light-emitting diode) are synchronized with the projection unit, so that a piece of image information (projection image) is optically superimposed onto the object (or the photo scene). In contrast to a purely electronic or digital superimposition during an image post-processing, this makes it advantageously possible, according to an example embodiment of the present invention, to make the object (or the photo scene) onto which the image information is optically superimposed visible and able to be experienced directly in the real scene—alternatively or in addition to displaying it on a device display.

Advantageous example embodiments and refinements of the present invention are described herein with reference to the figures.

According to one preferred refinement of the present invention, it is provided that the image information projected into the projection area in the first method step includes a piece of boundary information for displaying a boundary of the detection area, a projection of the boundary information into the detection area being deactivated during the second method step. This makes it advantageously possible to simplify the recording of the image for the user of the mobile device by using orientation markers, in particular when a display is not visible or unavailable for displaying the image to be recorded.

According to one preferred refinement of the present invention, it is provided that another piece of image information is projected into the detection area during the exposure of the recording medium. This makes it advantageously possible for the image information to be optically superimposed onto the detection area (in particular, including an object or a photo scene onto which the image information is superimposed). The additional image information is preferably essentially identical to the image information or it is another piece of image information (dynamically) adapted to the object with respect to the image information.

According to one preferred refinement, it is provided that the camera unit and the projection unit are synchronized, the camera unit and the projection unit being synchronized, in particular, in such a way that the exposure of the recording medium in the second method step is started at a certain line start of the image information projected by the projection unit, the camera unit and the projection unit being synchronized, in particular, in such a way that an integral number of projection images are detected by the recording medium for the duration of the exposure of the recording medium in the second method step. This makes it advantageously possible that the camera begins recording at a certain line start of the projection unit due to a synchronization of the projection operation and the image recording. The certain line start is preferably the image beginning of the image information (i.e., the first pixel). Due to the synchronization, the exposure duration (or recording duration of the camera unit) is preferably coordinated with an image repetition rate of the projection unit, so that an integral number of projection images is projected into the projection area within the recording time (or exposure duration) of the camera unit.

According to one preferred refinement, it is provided that a projection mapping method is carried out, the projected image information and/or the projected additional image information is/are aligned with a contour of an object positioned in the projection area. This makes it advantageously possible that, due to the use of the projection mapping method, the projected image is aligned with the contours of the object (or the photo scene), and different areas within the projection area (for example, the foreground area and background area) may thus be illuminated with different themes in each case (in particular, adapted to the particular area).

According to one preferred refinement, it is provided that the contour of the object is detected by the mobile device, the projection unit being configured, in particular, in such a way that the projected image information and/or additional image information is interactively adapted to the object. This makes it advantageously possible for an interactivity function to be provided by the projection unit, an infrared (IR) source of the projection unit, in particular, being used to provide the interactivity function, so that the projection unit has a camera function in the infrared range in addition to the projection function in the wavelength range visible to the human eye. In particular, the projection unit is designed in such a way that a perspective of the projection essentially exactly matches a perspective of the interactive camera function of the projection unit.

According to one preferred refinement, it is provided that, in the second method step, the recording medium of the camera unit is exposed during a main exposure time interval and during a post-exposure time interval, which follows the main exposure time interval, the detection area, in particular, being illuminated by ambient light, by a camera flash and/or by the projection unit during the post-exposure time interval, the detection area being, in particular, selectively illuminated, during the exposure with the aid of the projection unit. This makes it advantageously possible for a flash-like functionality to be provided by the projection unit, a visible image (for example a white image) being generated (which replaces, in particular, a camera flash) and/or the illumination takes place selectively (i.e., only the areas of the object are illuminated which are comparatively dark or appear to be comparatively dark on the image or whose intensity value is below an intensity threshold value). This makes it advantageously possible to selectively improve the contrast of the image and/or to set the exposure duration or aperture setting of the camera unit independently of the intensity values in comparatively dark areas. In particular, the projection unit is the only light source of the mobile device or a light source in addition to existing ambient light or to an existing camera flash (for example, an LED flash).

Another subject of the present invention is a mobile device for recording an image, the mobile device including a camera unit, a detection area being assigned to the camera unit, the mobile device including a projection unit, a projection area being assigned to the projection unit, the detection area and the projection area at least partially overlapping, the mobile device being configured in such a way that a piece of image information is projected into the detection area and a recording medium of the camera unit being subsequently exposed, the mobile device being configured to store the image generated by the exposure of the recording medium.

According to one preferred refinement, it is provided that the mobile device includes a synchronization element for synchronizing the camera unit and the projection unit, the synchronization means being configured, in particular, in such a way that the exposure of the recording medium in the second method step is started at a certain line start of the image information projected by the projection unit, the synchronization means being configured, in particular, in such a way that an integral number of projection images are detected by the recording medium for the duration of the exposure of the recording medium in the second method step. This makes it advantageously possible for the recorded image to reproduce the object onto which the image information is superimposed essentially completely and free of artefacts.

According to one preferred refinement, it is provided that the projection unit is a scanning 3D laser projector, the scanning 3D laser projector being configured to detect an object positioned in the projection area, the 3D laser projector being configured, in particular, in such a way that the projected image information and/or additional image information is interactively adapted to the object. This makes it advantageously possible for another piece of image information, which is adapted to the object, to be projected onto the object by reconstructing a three-dimensional shape of the object. A 3D model of the object is preferably generated as a function of the detection of the object and stored, in particular, in the mobile device. For example, the 3D model is stored, and a representation of the object is created with the aid of a 3D printer, or the representation of the object is integrated into a virtual 3D environment (3D computer game). In this application scenario, the 3D model does not initially have any retroaction on the projection image. According to one preferred alternative specific embodiment of the present invention, the projection image is adapted to the (3D) object as a function of the 3D model by generating a structured light image for detecting the (3D) object, preferably with the aid of infrared light, and projecting it onto the (3D) image, the image information generated by the projector (i.e., a visible image projected simultaneously with the structured light image) being adapted to the object.

### BRIEF DESCRIPTION OF THE DRAWINGS

FIG. 1 shows a schematic representation of a mobile device according to one exemplary specific embodiment of the present invention.

FIGS. 2 through 8 show schematic representations of multiple methods for recording an image according to exemplary specific embodiments of the present invention.

### DETAILED DESCRIPTION OF EXAMPLE EMBODIMENTS

The same parts are always provided with the same reference numerals and are therefore generally also named or mentioned only once in each case.

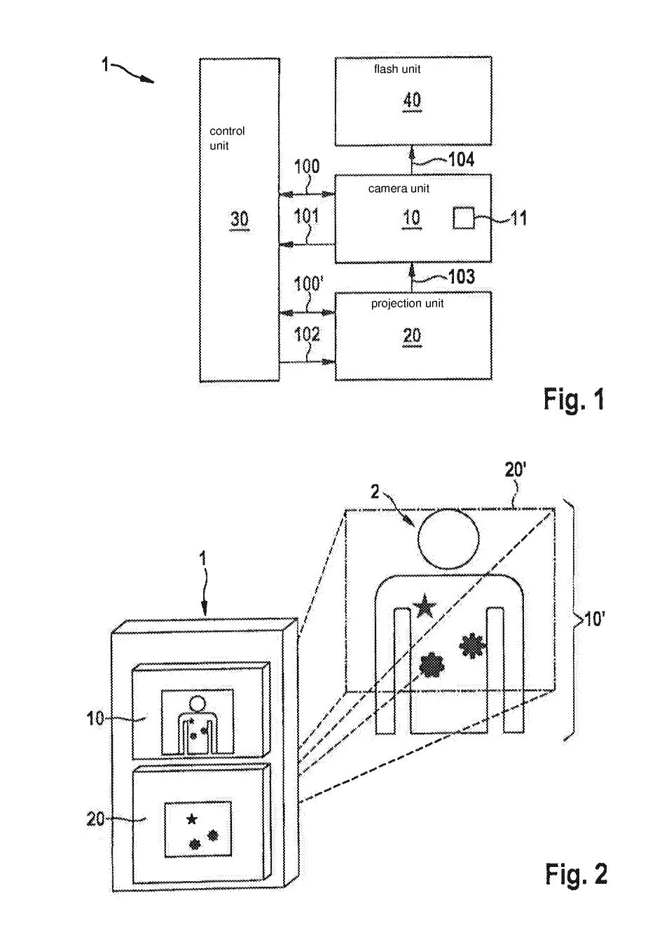

FIG. 1 shows a schematic representation of a mobile device 1 according to one exemplary specific embodiment of the present invention. Mobile device 1 for recording an image includes a camera unit 10, a projection unit 20, a control unit 30, control unit 30 including, in particular, a central processing unit (CPU). In particular, mobile device 1 in this case additionally includes a flash unit 40. A detection area 10′ is assigned to camera unit 10, an object 2 being detectable by camera unit 10 for recording an image of the object—when object 2 is positioned in detection area 10′. A projection area 20′ is furthermore assigned to projection unit 20, the detection area and the projection area at least partially overlapping (for example, as illustrated in FIG. 2).

According to the present invention, it is preferably provided that camera unit 10 and projection unit 20 are operated synchronously with each other so that the recording of the image takes place as a function of a time sequence of the variable image content, camera unit 10 and projection unit 20 being connected to a shared controller 30. In FIG. 1, a configuration channel between camera unit 10 and shared control unit 30 is represented by reference numeral 100, and another configuration channel between projection unit 20 and shared control unit 30 is represented by reference numeral 100′. Shared controller 30 includes, in particular, an image source and an image sink. Shared controller 30 is configured, in particular, in such a way that a piece of image information (which is referred to here as image content) is generated for projection unit 20 (represented here by the data channel illustrated by reference numeral 102). The image information is preferably generated as a function of a camera image continuously detected prior to the actual recording of the image (represented here by data channel 101) and as a function of the present operating state (for example, as a function of an activated trigger) of the mobile device. According to the present invention, an exposure beginning and exposure end of camera unit 10 is preferably subsequently synchronized with the image structure of projection unit 20 (i.e., in the second method step), so that the projection image (image information) superimposed onto object 2 (cf. FIG. 2) is detected by camera unit 10 essentially completely and free of artefacts. According to the present invention, an image synchronization signal (VSync) of projection unit 20 is preferably used as the trigger for the camera unit (cf. reference numeral 103 in FIG. 1). In particular, the image synchronization signal is transmitted from projection unit 20 to camera unit 10 when projection unit 20 begins projecting the first image line. FIG. 1 shows a trigger signal, represented by reference numeral 104.

FIGS. 2 through 8 show schematic representations of multiple methods for recording an image according to exemplary specific embodiments of the present invention.

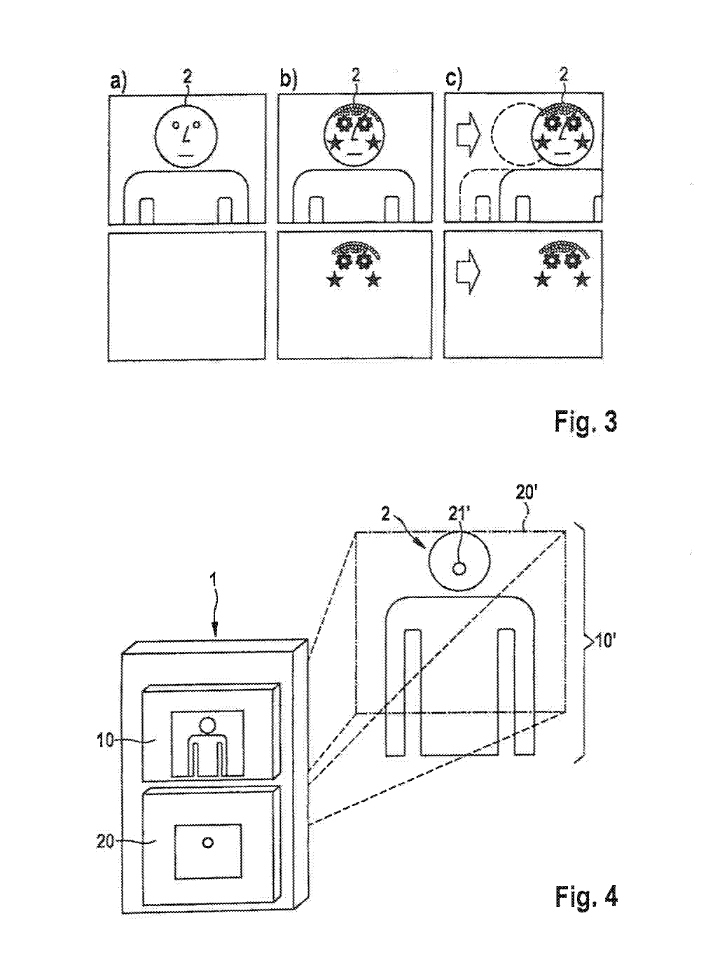

FIG. 2 shows an object 2 (a person in this case) positioned in a detection area 10′ of the camera unit, including a piece of image information (photo effects in this case) projected into projection area 20′ of projection unit 20. In this case, a piece of image information is optically superimposed onto object 2 during the recording of the image (i.e., in this case, a projection image is projected onto object 2 during the recording of the image). According to the present invention, the projected image information (i.e., the superimposed contents of the photo scene) is preferably dynamically adapted in that the camera image and/or additional feedback channels (for example, interactivity data of the projection unit and/or measured data of inertial sensors and/or measured data of distance sensors) are continuously evaluated by mobile device 1, and the size, position and/or predistortion of the projected contents are updated (so-called projection mapping). An object 2 (top) mapped into a photo scene or onto the camera image and the image information (projection image) of the projection unit (bottom) are illustrated in FIGS. 3a through 3c. The original photo scene without projected contents (i.e., without image information) is illustrated in FIG. 3). The photo scene, including projected contents (in this case, decorative elements on the face of a person) is illustrated in FIG. 3b, the image information automatically adapting to the contours (in this case, face proportions of the person). A variable photo scene is illustrated in FIG. 3c, the projected contents automatically following object 2 (i.e., being adapted dynamically).

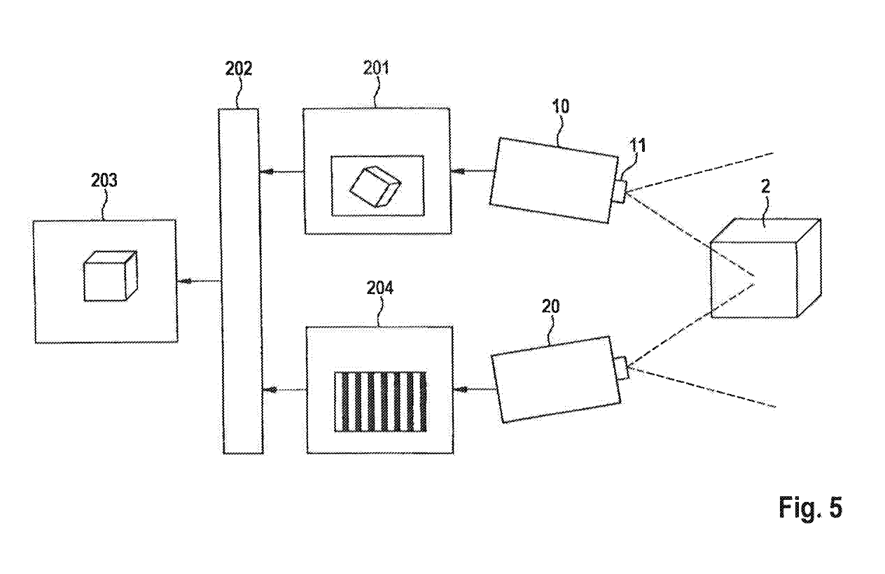

FIG. 4 shows an image of an object 2 being recorded, orientation markers (for example, a piece of boundary information in the form of a picture frame-like projection and/or a position marker 21′) being projected as image information into detection area 10′ (exclusively) prior to an image recording (and, in particular the projection of the image information being deactivated or not carried out—at least in the detection area—during the recording of the image). For example, the position of focus point 21′ is marked by the image information. According to the present invention, this makes it advantageously possible to also precisely select an image detail from positions where the user operating mobile device 1 does not see the display of mobile device 1. Scale markers are furthermore preferably projected into detection area 10′, so that a subsequent survey evaluation of the recorded image is facilitated, as is possible, for example, after a home viewing or a visit to a furniture store.

An object 2, which is illuminated with special patterns (stripes in this case) at a comparatively short distance is illustrated in FIG. 5. According to the present invention, projection unit 20 is preferably designed as a three-dimensional, scanning laser projector, mobile device 1 being configured in such a way that the spatial shape of the object is reconstructed from a spatial distortion (which is caused by the spatial, physical characteristic of object 2). According to the present invention, camera unit 10 and projection unit 20 are situated at a spatial distance from each other for this purpose. Camera unit 10 includes a recording medium 11, with the aid of which object 2 illuminated with the stripes is detected, so that a camera image is generated (illustrated by reference numeral 201). A reconstruction algorithm (cf. reference numeral 202) generates a 3D model (illustrated by reference numeral 203) from the camera image and, as a function of the generated 3D model, transmits a piece of image information relating to a projection image (cf. reference numeral 204) to projection unit 20, which projects the image information into projection area 20′.

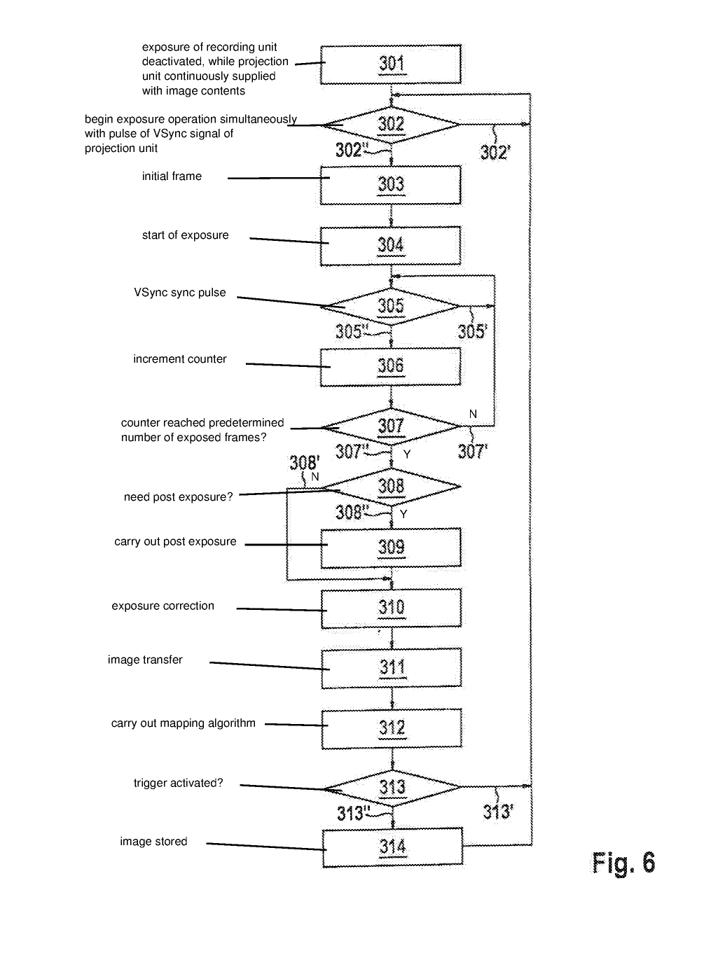

FIG. 6 shows a schematic representation of a method for recording an image with the aid of a mobile device 1 according to one exemplary specific embodiment of the present invention. In a first method step, a piece of image information is projected into detection area 10′ of the camera unit (the image information includes, for example, decorative elements, as shown in FIG. 2). In a second method step, which follows the first method step, a recording medium 11 of camera unit 10 is exposed (as shown, for example, in FIG. 1), and in a third method step, the image generated by the exposure of recording medium 11 is stored in mobile device 1. FIG. 6 shows a flowchart for the projection-synchronous image recording, the exposure of recording unit 11 being deactivated (for example, the camera shutter is closed) in an initial state (i.e., before the exposure in the second method step) of the camera unit (cf. reference numeral 301), while projection unit 20 is continuously supplied with image contents (by shared control unit 30). At the beginning (cf. reference numeral 302) of a new projection image (which is also referred to as a frame or image information), camera unit 10 begins the exposure operation of the second method step (cf. reference numeral 304) simultaneously (cf. reference numeral sequence 302, 302″) with a pulse of the VSync signal of projection unit 20 (which is transmitted over channel 103—see FIG. 1). Otherwise—i.e., if no pulse of the VSync signal is transmitted to camera unit 10, the camera unit waits for a pulse (see reference numeral sequence 302, 302′). Reference numeral 303 illustrates the initial frame (for example, the frame having number “0”); reference numeral 304 illustrates the start of exposure (start of main exposure). Each additional VSync pulse (cf. reference numeral sequence 305, 305″) increments a counter (illustrated by reference numeral 306), which counts the number of exposed frames since the start of exposure. If no pulse is present, the system waits for the next pulse (cf. reference numeral 305′). In the method step illustrated by reference numeral 307, a check is carried out of whether the counter has reached a predetermined number of exposed frames. If it has not, the loop is fed back via reference number 307′. If the predetermined number of frames to be exposed is reached by the counter (cf. reference numeral 307″), a check is carried out in the method step illustrated by reference numeral 308 of whether a post-exposure is necessary.

If this is not the case, the exposure operation is ended (cf. reference numeral sequence 308′, 310). Otherwise, 308″, a post-exposure, 309, is carried out before the end of the exposure operation, 310. For example, the post-exposure is carried out if the projected elements in the camera image already have a certain brightness, the object itself, however, appearing to be comparatively dark (or having a lower intensity value) in an area outside the projected elements. The post-exposure preferably follows the main exposure. After the end of exposure, an exposure correction is carried out in method step 310. An image transfer to a mapping algorithm (cf. reference numeral 312) is carried out in method step 311. In method step 313, a check is carried out of whether a trigger is activated. If this is not the case (cf. reference numeral 313′), the projection-synchronous image recording is fed back to the beginning (see reference number 302). If the trigger is activated (cf. reference numeral 313″), the image is stored (cf. reference numeral 314).

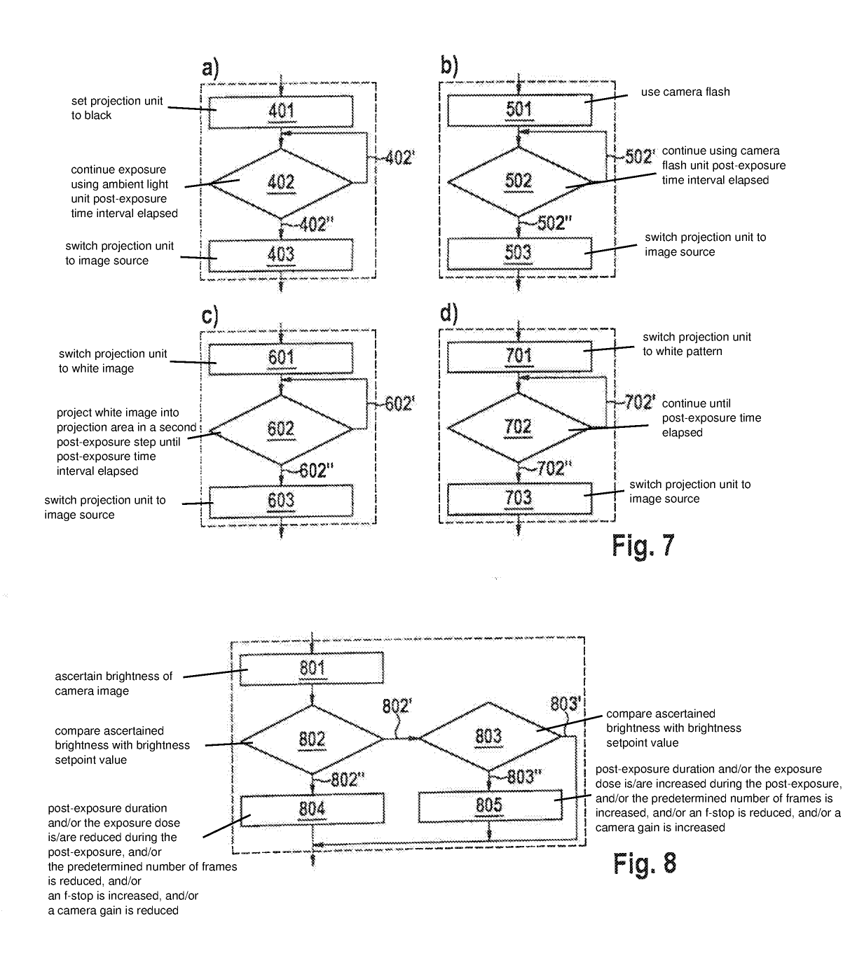

The post-exposure operation is illustrated in FIGS. 7a through 7d according to different specific embodiments of the present invention. In FIG. 7a, the projection unit is set to black (cf. reference numeral 401), and the exposure is continued using ambient light (cf. reference numeral 402′) until a post-exposure time interval has elapsed (cf. reference numeral sequence 402, 402″), the projector being subsequently switched to the image source (cf. reference numeral 403). Alternatively, see FIG. 7b, a camera flash is used (cf. reference numeral sequence 501, 502′) until the post-exposure time interval has elapsed (see reference numeral sequence 502, 502″, 503), the light quantity of the camera flash being less than the light quantity emitted by the projection unit during the main exposure. FIG. 7c shows that a camera flash-like functionality is provided by projection unit 20. In a first post-exposure step, 601, the projection unit is switched to a white image, the white image being projected into projection area 20′ in a second post-exposure step until a post-exposure time has elapsed (cf. reference numerals 602, 602′), the projection unit being switched to the image source in a third post-exposure step, 603, (when the post-exposure time interval has expired, 602″). A selective illumination of object 2 is illustrated in FIG. 7d, projection unit 20 being switched to “white pattern” and subsequently to “image source,” 703, during the post-exposure time interval (cf. reference numerals 701, 702, 702′) until the post-exposure time interval has elapsed (cf. reference numeral 702″).

The exposure correction according to the method step represented by reference numeral 311 in FIG. 6 is illustrated in FIG. 8, the exposure operation being regulated by the exposure correction in such a way that camera unit 10 is essentially held in an optimal working point. In particular, this is achieved in that a brightness of the camera image ascertained in a first exposure correction step, 801, is compared with a brightness setpoint value in a second exposure correction step, 802, 803. An f-stop is set during the main exposure and/or post-exposure, and/or a light sensitivity (camera gain) is set during the main exposure and/or post-exposure as a function of the comparison between an exposure duration and/or exposure dose of the main exposure and/or post-exposure. If the brightness value ascertained in the first exposure correction step, 801, is greater than the brightness setpoint value (cf. reference numeral 802″), the post-exposure duration and/or the exposure dose is/are reduced during the post-exposure, and/or the predetermined number of frames is reduced, and/or an f-stop is increased, and/or a camera gain is reduced (cf. reference numeral 804). If the brightness value ascertained in the first exposure correction step, 801, is less than the brightness setpoint value (cf. reference numerals 802′, 803, 803″), the post-exposure duration and/or the exposure dose is/are increased during the post-exposure, and/or the predetermined number of frames is increased, and/or an f-stop is reduced, and/or a camera gain is increased (cf. reference numeral 805). If the brightness value essentially corresponds to the brightness setpoint value, a change of the parameters is avoided (cf. reference numeral 803′).

1-10. (canceled)

11. A method for recording an image using a mobile device, the mobile device including a camera unit, a detection area being assigned to the camera unit, the mobile device including a projection unit, a projection area being assigned to the projection unit, wherein the detection area and the projection area at least partially overlap, the method comprising:
in a first method step, projecting a piece of image information into the detection,
in a second method step which follows the first method step, a recording medium of the camera unit; and
in a third method step, storing an image generated by the exposure of the recording medium in the mobile device.

12. The method as recited in claim 11, wherein the image information projected into the projection area in the first method step includes a piece of limiting information for displaying a limitation of the detection area, a projection of the limiting information into the detection area being deactivated during the second method step.

13. The method as recited in claim 11, wherein additional piece of image information is projected into the detection area during the exposure of the recording medium.

14. The method as recited in claim 11, wherein the camera unit and the projection unit are synchronized, the camera unit and the projection unit being synchronized in such a way that the exposure of the recording medium in the second method step is started at a certain line start of the image information projected by the projection unit, the camera unit and the projection unit being synchronized in such a way that an integral number of projection images are detected by the recording medium for a duration of the exposure of the recording medium in the second method step.

15. The method as recited in claim 13, wherein a projection mapping method is carried out, wherein at least one of the projected image information and the projected additional image information is aligned with a contour of an object positioned in the projection area.

16. The method as recited in claim 15, wherein the contour of the object is detected by the mobile device, the projection unit interactively adapting the at least one of the projected image information and the additional image information, to the object.

17. The method as recited in claim 11, wherein, in the second method step, the recording medium of the camera unit is exposed during a main exposure time interval and during a post-exposure time interval following the main exposure time interval, the detection area being illuminated by at least one of ambient light, a camera flash, and the projection unit, during the post-exposure time interval, the detection area being selectively illuminated during the exposure with the aid of the projection unit.

18. A mobile device for recording an image, the mobile device comprising:
a camera unit, a detection area being assigned to the camera unit; and
a projection unit, a projection area being assigned to the projection unit, wherein the detection area and the projection area at least partially overlap;
wherein the mobile device is configured in such a way that a piece of image information is projected into the detection area, and a recording medium of the camera unit is subsequently exposed, the mobile device being configured to store the image generated by the exposure of the recording medium.

19. The mobile device as recited in claim 18, wherein the mobile device includes a synchronization element for synchronizing the camera unit and the projection unit, the synchronization element being configured in such a way that the exposure of the recording medium is started at a certain line start of the image information projected by the projection unit, the synchronization element being configured in such a way that an integral number of projection images are detected by the recording medium for a duration of the exposure of the recording medium.

20. The mobile device as recited in claim 18, wherein the projection unit is a scanning 3D laser projector, the scanning 3D laser projector being configured to detect an object positioned in the projection area, the 3D laser projector being configured in such a way that at least one of the projected image information and additional image information, is interactively adapted to the object.
